(19) United States
(12) Patent Application Publication
(10) Pub. No.: US 2020/0192952 A1
(43) Pub. Date: Jun. 18, 2020

(54) METHOD AND SYSTEM FOR IMPAIRING AND DETERRING TARGETED ADVERTISING

(71) Applicant: International Business Machines Corporation, Armonk, NY (US)

(72) Inventors: Francois Pierre Luus, Pretoria (ZA); Ashley Daniel Gritzman, Johannesburg (ZA); Chane Simone Moodley, Gauteng (ZA); Komminist Weldermariam, Nairobi (KE); Ismail Yunus Akhalwaya, Johannesburg (ZA)

(21) Appl. No.: 16/221,520

(22) Filed: Dec. 16, 2018

(51) Int. Cl. G06F 16/9535; G06Q 50/00; G06Q 30/02; G06F 17/27

(52) U.S. Cl. CPC G06F 16/9535; G06F 17/279; G06Q 30/0269; G06Q 50/01

(57) ABSTRACT

A computer-implemented method of deterring automated online profiling in social media networks is provided. The invention also extends to a corresponding computer system and computer program product. The method includes monitoring and extracting, using a social website monitor, user-specific content from a social media platform accessed by a user. The method then comprises generating, using a profile visualizer, a perceived system-generated user profile based upon the extracted user-specific content and graphically representing to the user, using the profile visualizer and a graphical display, the perceived system-generated user profile of the user. Finally, the method includes suggesting, using a submission transformer, potential changes to content submitted by the user to the social media platform without altering intent of the content, to avoid targeted advertising based upon automated online profiling. The submission transformer includes a fact corrector, controversy ameliorator, and an opinion obfuscator for introducing ambivalent, ironic, sarcastic or colloquial language into the content to obfuscate user opinion.

### BACKGROUND

The present invention relates to data analytics and machine learning methods and systems for analyzing social media user profiles and shared user content for the purposes of influencing the manner in which content is shared online, for example on social media platforms, to impair or deter targeted advertising based upon automatic online profiling techniques.

### SUMMARY

According to an embodiment of the present invention, there is provided a computer-implemented method of deterring automated online profiling in social media networks, the method being implemented on a computer system including a processor and a graphical display, the method including:

monitoring and extracting, using a social website monitor, user-specific content from a social media platform accessed by a user;

generating, using a profile visualizer, a perceived system-generated user profile based upon the extracted user-specific content;

graphically representing to the user, using the profile visualizer and the graphical display, the perceived system-generated user profile of the user; and

suggesting, using a submission transformer, potential changes to content submitted by the user to the social media platform without altering intent of the content, to avoid targeted advertising based upon automated online profiling. Embodiments of the present invention extend to a corresponding computer system and a computer program product.

### BRIEF DESCRIPTION OF THE DRAWINGS

FIG. 1A illustrates a functional block diagram of a computer program product in accordance with an embodiment of the invention;

FIGS. 1B to 1E illustrate in greater detail different constituent parts of FIG. 1A; and

FIG. 2 illustrates a flow diagram of a method in accordance with another embodiment of the invention.

### DETAILED DESCRIPTION

Examples and aspects are discussed below with reference to the FIGS. However, it should be understood that the detailed description given with respect to these FIGS is for explanatory purposes only, and not by way of limitation.

An online user's social media content can be used to profile the user and to target specific external content to the user in an attempt to influence the user in some way.

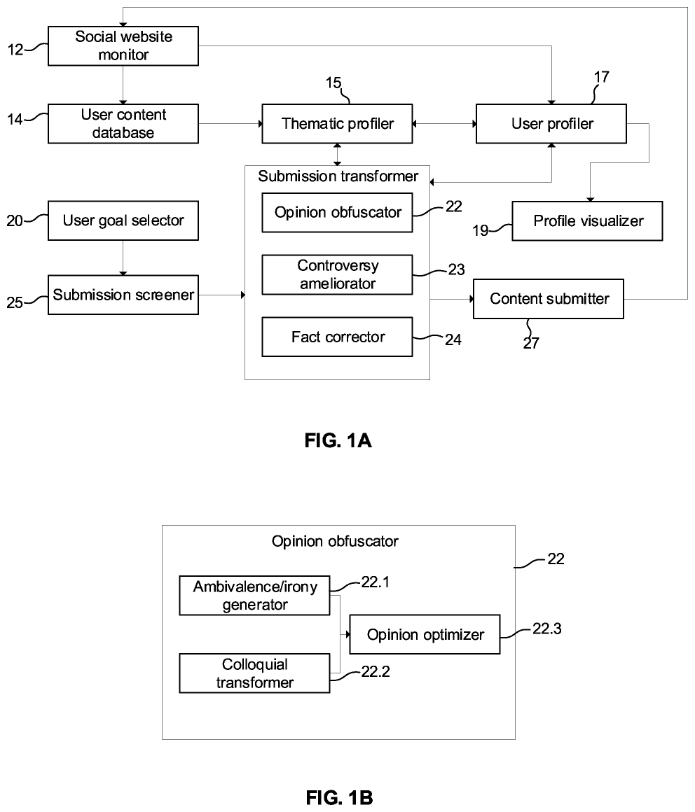

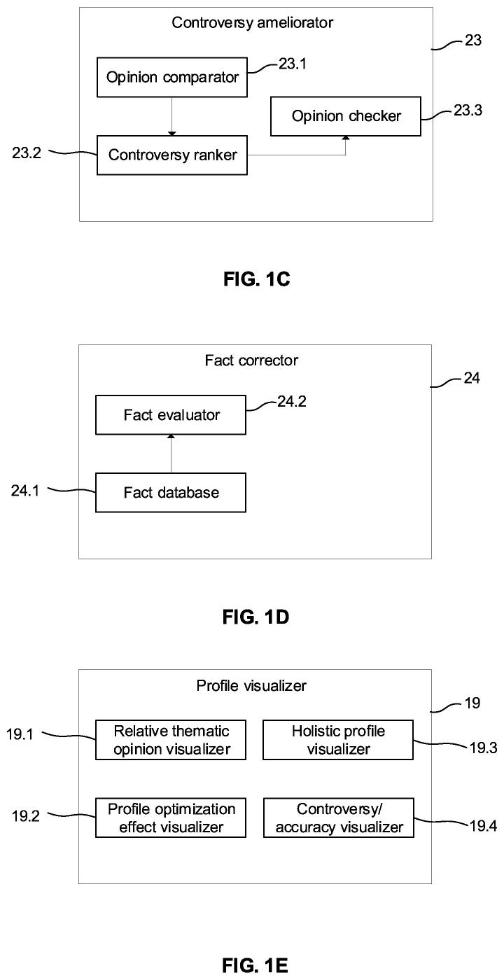

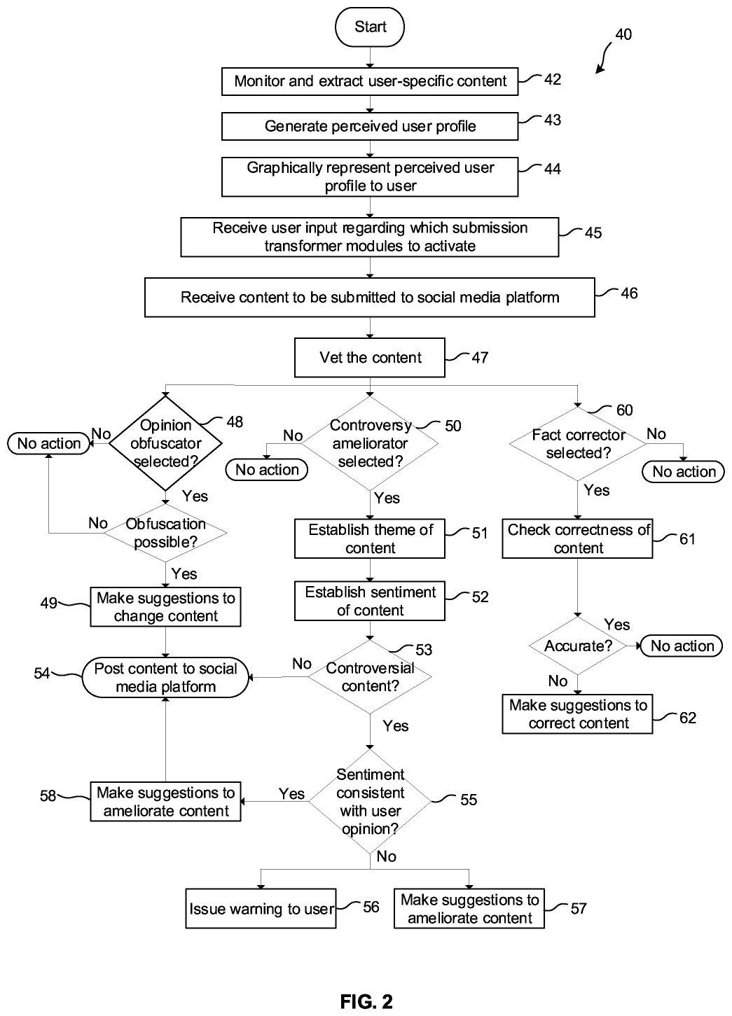

As illustrated in FIGS. 1A to 1E, a computer program product comprises a number of software-implemented modules represented by separate blocks. The computer program product comprises a computer readable medium having program instructions stored thereon, which, when executed by a computer system enable the computer system to function in a manner which deters automated online profiling in social media networks in an attempt to avoid online targeted advertising. In FIG. 2, reference numeral 40 refers generally to a computer-implemented method of deterring automated online profiling in social media networks. To this end, the computer program product includes a social website monitor 12 which is configured to monitor and extract 42 user-specific social media content by way of a web-browser plugin, for example, from social media networks. All extracted social media content may be associated with a specific user. The extracted user-specific content is entered into and stored in a user content database 14 with metadata relating to time, location and type of content collected.

The computer program product may further include a thematic profiler 15 which is coupled to the user content database 12, a user profiler 17 and a profile visualizer 19. The thematic profiler 15 may take the collected social media content in the user content database 12 and perform theme extraction and storing, opinion sentiment extraction and storing, opinion/polarity extraction, and, characterize every user in terms of measured opinion sentiments for available opinions within available themes. The user profiler 17 combines collected or extracted demographic and psychographic profiles into a holistic profile description for each user, storing these descriptions in a user profile database.

The profile visualizer 19 generates 43 a perceived system-generated user profile based upon the extracted user-specific content and graphically represents 44, via a graphical display of the computer system, the perceived system-generated user profile to the user. There may be a visualization tab provided in a plugin dashboard which displays relative thematic opinion, profile optimization effects, holistic profile and accuracy/controversy information for the specific user.

The computer program product further includes a user goal selector 20 which is configured to receive 45, via a graphical user interface, user input regarding activation/deactivation and relevance of any one or more submission transformer modules. The submission transformer modules may include an opinion obfuscator 22, a controversy ameliorator 23 and a fact corrector 24, all of which are configured to make content alteration suggestions in an attempt to ameliorate controversial submissions made by the user and/or obfuscate user opinion or correct inaccuracies. The user may select which of these modules should be activated or deactivated, and to what degree or level the modules should be allowed to influence content submissions using conventional input techniques such as relevance slider bars, radio buttons, toggle switches, drop-down list etcetera. The method may include receiving 45 user input indicative of whether or not the user wants to use any one or more of the opinion obfuscator, controversy ameliorator, and fact corrector to vet content submitted by the user. These submission transformer modules are configured to provide content alteration suggestions, and alternative possibilities can be listed and ranked based on the user's relevance selection.

Using conventional user input devices, the user may enter content, i.e. text, images, and/or videos to the web-browser or computer system via a graphical user interface with a view of submitting it to the social media website. Prior to posting the content to the social media website, the content is received at block 46. Furthermore, there may be provided a submission screener 25 for vetting 47 the content in terms of user goals selected. The submission screener 25 is a feedback-based module that submits the content input by the user, i.e. the content that the user wants to submit to the social media website, to the submission transformer and checks the content and revised/altered content against the user goals selected. The three submission transformer modules, namely opinion obfuscator 22, controversy ameliorator 23 and fact corrector 24, each produce suggestions with metadata evaluating a goal improvement/state, and when the state is in correspondence with a goal state, a content submitter 27 is activated. The goal states can be recorded in terms of values from 0 (violates) to 1 (conforms).

Provided that the opinion obfuscator 22 was activated/selected 48 by the user, the opinion obfuscator 22 may be configured to transform the content intended for submission by the user by suggesting changes 49 to the content by introducing any one or more of ambivalent, ironic, sarcastic or colloquial/slang language into the content in order to obscure a true opinion reflected by the content, when the content is interpreted by automated online profiling machine learning techniques. To this end, the opinion obfuscator 22 may include an ambivalence/irony generator 22.1, a colloquial transformer 22.2 and an opinion optimizer 22.3.

Consider the following example. An initial submission is made by the user to the submission screener 25 which reads, “Candidate B has had a very successful land reform policy, while Candidate A's stance on land reform was an absolute disaster, just like most of Candidate A's other horribly short-sighted policies.” The opinion obfuscator 22 may be configured to suggest that the initial submission be changed to the following: “Yes Candidate A's policy on land reform has really worked out well the past couple of years, wish Candidate B had adopted the same far-sighted policies.” The ambivalence/irony generator 22.1 has introduced sarcasm such that the statement is reversed but an agent familiar with the facts would still be able to interpret the intended opinion correctly. However, an automated online profiling technique may not be able to interpret the intended meaning correctly. Part-of-speech tagging, named entity recognition/disambiguation, and word sense recognition/disambiguation and statement negation are natural language processing (NLP) techniques which the ambivalence/irony generator 22.1 may utilize.

The colloquial transformer 22.2 may be configured to use lookup tables to replace phrases with alternative wording which requires more sophisticated NLP processing accurately to capture the intended meaning. This module is configured to receive the intended submission as an input and to output an alternative submission with the same opinion but using colloquialisms and slang.

On the other hand, the opinion optimizer 22.3 receives as input the alternative submissions from the colloquial transformer 22.2 and the ambivalence/irony generator 22.1 and performs thematic profiling ablation to see how the profile opinion/polarity changes if the submission is made. Generally, the opinion optimizer 22.3 will aim to maximize ambivalence or confusion of the submission, so as to produce maximum impairing and deterring of external online profiling of the user. The opinion optimizer 22.3 operates by considering every alternative submission produced and choosing the one alternative which produces maximum confusion of profile polarities. The opinion obfuscator 22 may therefore be configured to output an alternative wording for the intended submission that makes it more difficult accurately to profile the user.

The controversy ameliorator 23 may be configured to receive as input the initial submission and to output an alternative submission that reduces an estimated expected social controversy of the content. Provided that the user selected 50 to activate the controversy ameliorator, the method 40 may include establishing 51 a theme of the content using a theme extractor and establishing 52 a sentiment of the content submitted by the user using a sentiment analyzer.

To this end, the controversy ameliorator 23 may include an opinion comparator 23.1 which may be configured to compare the theme and sentiment of the user's post or content, to a content polarity database to determine whether or not the theme is controversial. The method may include establishing 53 whether or not the content submitted by the user is considered controversial by comparing the established content theme and sentiment against the content polarity database. If the content is not considered controversial, it may be submitted to the content submitter 27 and posted to the social media platform 54. The controversy ameliorator 23 may further include a controversy ranker 23.2 through use of which a controversy ranking may be assigned to the content. The controversy ranking values may be “high” or “low”. A controversy ranking of “high” may indicate that the user's post discusses a highly polarized topic (e.g. “gun laws in the USA”), or that the user's post is contrarian to a certain general consensus (e.g. the user is against saving the Rhinos). A controversy ranking of “low” indicates that the user's post discussed a topic that is not highly polarized (e.g. what's your favourite colours), or that the user's post is in agreement with public consensus (e.g. the user is in favour of saving the Rhinos). If an output of the controversy ranker 23.2 indicates that the content is considered to be controversial, the method may include determining 55, using an opinion checker 23.3, whether or not the sentiment of the content submitted by the user is consistent with a predetermined user opinion.

If the sentiment of the content submitted by the user is inconsistent with the predetermined user opinion, the method may include issuing 56, using the controversy ameliorator, a warning message to the user. Alternatively, the method may include suggesting 57 changes to the content in order to ameliorate the controversy thereof.

In other words, in the event that the user's post is predicted to be controversial, then the opinion checker 23.3 consults the opinion database to see if the current post is consistent with opinions held by the user. For example, if the user's current post is in favour of tighter gun controls, and the user has made previous posts voicing this same opinion, then the opinion checker 23.3 will not raise a flag. Alternatively, if this is the first time that the user is posting on the gun control question, then the opinion database will raise a flag to alert the user that the post may be controversial.

In case the user's post is controversial, and the opinion checker 23.3 suggests that the post is consistent with previous opinions expressed by the user, then the controversy ameliorator module may be activated and may encourage the user to reconsider or rephrase their post. Alternatively, the controversy ameliorator may automatically suggest 58 specific words or phrases be changed. Consider the following example of an initial submission: “I totally support saving endangered wildlife, but I am against gun control and I likewise fully support Candidate A's policies, not just on gun control but also on immigration.” A suggested amended or altered submission may read: “I totally support saving endangered wildlife, but the issue of gun control should be considered separately as a different issue.”

The fact corrector 24 notifies the user of errors in the content and suggests corrections to facts and meta-facts in the content. Provided the user selected 60 to activate the fact corrector 24, the method includes checking 61 correctness of the content submitted by the user by having regard to a fact database 24.1. The fact corrector 24 further includes a fact evaluator 24.2. If any inaccuracies are picked up, the method includes making 62 suggested changes to correct the content.

For example, the user may intend on mentioning John Doe, as evidenced by previous conversation threads and social website content, but accidentally mentions Jack Doe in his intended submission. Accordingly, the fact corrector 24 suggests that @JackDoe be corrected to @JohnDoe.

Factual statements in the intended submission can be extracted with NLP techniques such as part-of-speech tagging, named entity recognition/disambiguation, word sense recognition/disambiguation and semantic relationship extraction. The fact database 24.1 is used as a lookup table where named entities are used as prioritized reference and all corresponding items retrieved from the database. If the intended statement is in conflict with any of the retrieved facts, then the fact evaluator 24.2 produces a negative result. Meta-facts are facts about the submission itself, e.g. does it contain an attachment as may be claimed, is it morning, when the text includes “Good Morning”, for example, is it addressed to the right people etc.

The fact database 24.1 may contain a comprehensive list of (named entity, relationship) tuples, as an example, encoding facts and relationships between named entities, which can be used as lookup table to validate user statements.

The profile visualizer 19 may include a relative thematic opinion visualizer 19.1, a profile optimization effect visualizer 19.2, a holistic profile visualizer 19.3 and a controversy/accuracy visualizer 19.4. A user's profile may be defined as a set of sentiments about opinions organized by theme. The relative thematic opinion visualizer 19.1 shows a sentiment bar chart for every theme, where every bar relates to an opinion, and where the user's sentiment toward the opinion is given as well as the average sentiment over all entities in the social network of the user. Likewise, the visualization takes the user-specific measures of thematic opinion and contrasts it against measures and statistics over the social network of the user.

The profile optimization effect visualizer 19.2 shows ablation (with/without obfuscation/amelioration/correction) measures to indicate utility and efficacy of the proposed system in impairing and deterring online profiling. These measures include but are not limited to the thematic opinion sentiment polarity before and after system intervention.

The holistic profile visualizer 19.3 includes categorical/numerical entries describing the demographic profile of the user. The controversy/accuracy visualizer 19.4 shows ablation measures for controversy and fact correction specifically, visualized as number of corrections made, differentiated by theme, and statistics of thematic/opinion controversy such as most frequent controversial opinion the user intends on submitting.

The method 40 therefore includes suggesting, using any one or more of the submission transformer modules, potential changes to content submitted by the user to the social media platform without altering intent of the content, to avoid targeted advertising based upon automated online profiling.

In addition, the method may include populating the content polarity database by performing natural language processing, image processing and video processing on text, images and video content extracted from various social media platforms in order to extract themes and corresponding sentiments of these themes and storing the extracted themes and corresponding sentiments on the content polarity database. Furthermore, the method may include assigning either a high or low polarity value to each extracted theme, high polarity serving to indicate that the theme is highly controversial and low polarity indicating that there is consensus in opinion regarding the theme in question.

The computer system and associated method in accordance with an embodiment of the invention may help a user to understand how data analytics/machine learning systems perceive their thematic preferences and profile polarizations. It may help the user to understand what effect altering, adding or removing content from a post will have on impairing, confusing and deterring such automated data analytics systems by making content suggestions of alternative phrases, colloquialisms, slang to use or words/sentences to leave out of their posts.

Similarly, the embodiment of the invention may help the user understand how other humans or autonomous agents, robots or artificial intelligence agents may perceive the content that they post online. The computer program product, method and system may either alert the user, automatically correct, withhold, anonymize, or obfuscate part of the content if it is deemed controversial, offensive or inaccurate.

The system and method 40 aim to pre-process user's online submissions and issue advice, suggestions, warnings and alterations, where appropriate. The proposed system and method in accordance with the embodiment of the invention may deconstruct user profiles according to automated profiling and display profile details to the user using the profile visualizer 19, and, in addition, it may make a variety of recommendations and suggestions for obfuscation of the user's profile.

The method and system may teach for the construction of a plurality of consistent profiles. Such profiles may act as a filter, obfuscator, and or augmenter between an individual or organisation and a given community or service. Such profiles may store both a private and public view. Such profiles may have personality traits that may or may not entail the personality traits of the controlling entity. For instance, an individual might be introverted and may use the system and method to teach profiles that portray an extroverted and easy-going personality to a given community. The method may include configuring a consistent online profile for an individual, organization or artificial intelligence agent for one or more online services or across a plurality of services.

The method may further be used to ensure a consistent online profile for an individual, organization or AI agent for one or more online services or across a plurality of services. The method may further be used to ensure consistency and culturally or demographically targeted messages across global media despite a plurality of users. The method may further be used to maintain consistent answers to security questions. The method may further be used to create an attractive profile to a given group of people by a person or organization. The method may further be used to ensure consistent communications for a chosen profile personality by a person or organization. The method may include monitoring and identifying online events, such as an election event, protest, advertising event and so on, attempting to mislead targeted users of social media and causing the opinion obfuscator to update. The method may include monitoring and identifying online events offending targeted social media users and causing the opinion obfuscator to update.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create module for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process (or method), such that the instructions which execute on the computer, other programmable apparatus, or other device implement the functions/acts specified in the flowchart and/or block diagram block or blocks.

The flowchart and block diagrams in the FIGS illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method of deterring automated online profiling in social media networks, the method being implemented on a computer system including a processor and a graphical display, the method including:
monitoring and extracting, using a social website monitor, user-specific content from a social media platform accessed by a user;
generating, using a profile visualizer, a perceived system-generated user profile based upon the extracted user-specific content;
graphically representing to the user, using the profile visualizer and the graphical display, the perceived system-generated user profile of the user; and
suggesting, using a submission transformer, potential changes to content submitted by the user to the social media platform without altering intent of the content, to avoid targeted advertising based upon automated online profiling.

2. A method as claimed in claim 1, which includes receiving as user input, at a submission screener, the content submitted by the user to the social media platform.

3. A method as claimed in claim 2, which includes vetting, using the submission screener, the content submitted by the user prior to making suggested changes to the content.

4. A method as claimed in claim 3, wherein the submission transformer includes an opinion obfuscator, the method including suggesting changes to the content submitted by the user, using the opinion obfuscator, by introducing any one or more of ambivalent, ironic, sarcastic or colloquial language into the content in order to obscure a true opinion reflected by the content when interpreted by an automated online profiling machine.

5. A method as claimed in claim 4, wherein the submission transformer includes a controversy ameliorator, the method including establishing, using a theme extractor, a theme of the content submitted by the user.

6. A method as claimed in claim 5, which includes establishing, using a sentiment analyzer, a sentiment of the content submitted by the user.

7. A method as claimed in claim 6, which includes establishing, using a controversy ranker, whether or not the content submitted by the user is considered controversial by comparing the established content theme and sentiment against a content polarity database.

8. A method as claimed in claim 7, wherein, if an output of the controversy ranker indicates that the content is considered to be controversial, the method includes determining, using an opinion checker, whether or not the sentiment of the content submitted by the user is consistent with a predetermined user opinion.

9. A method as claimed in claim 8, wherein, if the sentiment of the content submitted by the user is inconsistent with the predetermined user opinion, the method includes issuing, using the controversy ameliorator, a warning message to the user.

10. A method as claimed in claim 8, wherein, if the sentiment of the content submitted by the user is inconsistent with the predetermined user opinion, the method includes suggesting, using the controversy ameliorator, changes to the content in order to ameliorate the controversy thereof.

11. A method as claimed in claim 7, which includes populating the content polarity database by performing natural language processing, image processing and video processing on text, images and video content on various social media platforms in order to extract themes and corresponding sentiments of these themes and storing the extracted themes and corresponding sentiments on the content polarity database.

12. A method as claimed in claim 11, which includes assigning either a high or low polarity value to each extracted theme, high polarity serving to indicate that the theme is highly controversial and low polarity indicating that there is consensus in opinion regarding the theme in question.

13. A method as claimed in claim 7, wherein the submission transformer includes a fact corrector, the method including checking, using the fact corrector, correctness of the content submitted by the user by having regard to a fact database and suggesting changes to any inaccuracies picked up.

14. A method as claimed in claim 13, wherein the method includes receiving, using a user goal selector, user input indicative of whether or not the user wants to use any one or more of the opinion obfuscator, controversy ameliorator, and fact corrector to vet content submitted by the user.

15. A method as claimed in claim 1, which includes monitoring and identifying online events offending targeted social media users and causing the opinion obfuscator to update.

16. A computer system for deterring automated online profiling in social media networks, the computer system including:
a processor;
a graphical display coupled to the processor;
at least one user input device, coupled to the processor; and
a computer readable storage medium having stored thereon program instructions executable by the processor to direct the computer system to:
monitor and extract, using a social website monitor, user-specific content from a social media platform accessed by a user;
generate, using a profile visualizer, a perceived system-generated user profile based upon the extracted user-specific content;
graphically represent to the user, using the profile visualizer and the graphical display, the perceived system-generated user profile of the user; and
suggest, using a submission transformer, potential changes to content submitted by the user to the social media platform without altering intent of the content, to avoid targeted advertising based upon automated online profiling.

17. A computer system as claimed in claim 16, wherein the program instructions executable by the processor direct the computer system to vet, using a submission screener, the content submitted by the user prior to making suggested changes to the content.

18. A computer program product comprising a computer-readable medium having program instructions stored thereon which are executable by a computer system to enable the computer system to:
monitor and extract, using a social website monitor, user-specific content from a social media platform accessed by a user;
generate, using a profile visualizer, a perceived system-generated user profile based upon the extracted user-specific content;
graphically represent to the user, using the profile visualizer and a graphical display, the perceived system-generated user profile of the user; and
suggest, using a submission transformer, potential changes to content submitted by the user to the social media platform without altering intent of the content, to avoid targeted advertising based upon automated online profiling.
